(19) United States
(12) Patent Application Publication
(10) Pub. No.: US 2021/0043900 A1
(43) Pub. Date: Feb. 11, 2021

(54) SYSTEM, METHOD AND APPARATUS FOR SMART VENTILATION IN HAZARDOUS LOCATIONS

(71) Applicant: Saudi Arabian Oil Company, Dhahran (SA)

(72) Inventors: Rami A. Al-Ghanim, Dhahran (SA); Abdullah Y. Al-Hassan, Dhahran (SA); Fayaz S. Alanzi, Dhahran (SA)

(21) Appl. No.: 16/534,822

(22) Filed: Aug. 7, 2019

(51) Int. Cl. H01M 2/12

(52) U.S. Cl. CPC H01M 2/1223; H01M 2/1264

(57) ABSTRACT

A method of ventilating a battery room comprises detecting a hydrogen concentration in the battery room, determining whether the hydrogen gas concentration is at or above a first threshold concentration, activating two or more exhaust fans to ventilate the battery room simultaneously when the battery charging process is triggered or when the hydrogen gas concentration is at or above the first threshold, and identifying a location in the battery room at which hydrogen is being released. In certain embodiments, notifications are generated and provided concerning the identified location in the battery room at which hydrogen is being released.

### FIELD OF THE DISCLOSURE

The present invention relates to detecting and remediating a hazardous level of a toxic gas, and, more particularly, relates to a system, method and apparatus for smart ventilation to remove excess hydrogen gas at hazardous locations.

### BACKGROUND OF THE DISCLOSURE

Complex IT installation often require a large number of batteries for backup power and other uses. The batteries are usually stored in banks in rooms specifically allocated for them. The batteries utilized can include lead-acid batteries which have an associated serious safety hazard. Wet-cell lead-acid batteries release hydrogen (H₂) gas during charging processes. Released hydrogen can accumulate in the room and lead to a destructive explosion in the absence of proper ventilation due to the fact that hydrogen gas is highly flammable.

A conventional method for ventilating battery rooms employs two exhaust fans which operate alternatively in compliance with an instituted safety standard. That is, only one fan operates at a time regardless of the air condition in the battery room. The conventional ventilation method is aimed to ensure that the hydrogen concentration does not exceed 1% of the total air volume of the battery room. However, because the risk of accumulated hydrogen increases in proportion to the number of lead-acid battery cells stored in the battery room, and hydrogen release can increase significantly during the charging and discharging process, the conventional ventilation method is not sufficient to protect against the hydrogen gas accumulation beyond the 1% level. The dangers of hydrogen accumulation are exacerbated by the fact hydrogen has is odorless, colorless, and tasteless such that elevated concentrations of hydrogen cannot be detected by human senses.

### SUMMARY OF THE DISCLOSURE

It would therefore be advantageous to provide a system and to augment ventilation capacity proactively during the charging process or when hydrogen concentrations approach hazardous levels.

The disclosure provides a method of ventilating a battery room and it comprises activating the fan set together proactively as soon as the battery charging is started in order to prevent hydrogen accumulation, detecting a hydrogen concentration in the battery room, determining whether the hydrogen gas concentration is at or above a first threshold concentration, activating two or more exhaust fans to ventilate the battery room simultaneously when the hydrogen gas concentration is at or above the first threshold, and identifying a location in the battery room at which hydrogen is being released.

In certain embodiments, It is determined whether any batteries in the battery room are currently being charged and the step of activating the two or more exhaust fans to ventilate the battery room simultaneously activates the fans if the batteries are determined to be in a state of presently being charged or if the hydrogen gas concentration is at or above the first threshold concentration.

In certain embodiments, at least one of a sound and a visual alert is activated when the hydrogen gas concentration is at or above the first threshold to warn personnel against entrance into the battery room.

The battery charger is integrated with the disclosed system to provide proactive ventilation as soon as the battery charging is started. This is to proactively prevent the hydrogen accumulation.

In certain embodiments, it is determined whether the whether the hydrogen gas concentration is at or above a second threshold concentration higher than the first threshold concentration. If so, charging of batteries in the battery room is halted.

In some implementations, the battery room contains a plurality of battery banks and a plurality of hydrogen sensors. There is a hydrogen sensor positioned at the gas outlets of each of the plurality of battery banks. The location at which hydrogen is being released is determined based on which of the plurality of hydrogen sensors in the battery room detects an elevated hydrogen concentration.

The plurality of hydrogen sensors can further include a ceiling sensor. The step of determining whether the hydrogen gas concentration is at or above a first threshold concentration can include detecting a hydrogen concentration at or above the first threshold at one of a) two of the plurality of hydrogen sensors positioned at gas outlets of the battery banks, or b) at one of the plurality of hydrogen sensors positioned at gas outlets of the battery banks and at the ceiling sensor.

Some embodiments of the method include generating a notification and providing it to personnel when the hydrogen gas concentration is at or above the first threshold. The notification can indicate the identified location in the battery room at which hydrogen is being released.

When the hydrogen gas concentration falls below the first threshold, the two or more exhaust fans are operated alternately.

A system for ventilating a battery room is also disclosed herein. The system includes a battery charger interfaced with the room's set of exhaust fans in order to proactively activate the fans simultaneously as soon as the charging process is started, a plurality of exhaust fans positioned in the battery room, a plurality of battery banks positioned in the battery room containing one or more batteries, a plurality of hydrogen sensors, at least one of the plurality of hydrogen sensors positioned adjacent to each one of the plurality of battery banks, a hydrogen detector coupled to the plurality of hydrogen sensors and a monitoring device coupled to the hydrogen detector and to the plurality of exhaust fans. The hydrogen detector is operative to receive output from the plurality of hydrogen sensors and to generate a signal indicating a hydrogen concentration detected by the plurality of hydrogen sensors and the monitoring device is configured to operate a fan control system to activate two or more of the plurality of exhaust fans to operate simultaneously upon receipt of a signal from the hydrogen detector indicating that the hydrogen concentration is at or above the first threshold. The monitoring device can be configured to generate notifications and provide such notifications to personnel including the identified location of the hydrogen release.

In certain embodiments, the system further comprises a battery charger coupled to the monitor. The monitor can be configured operate the fan control system to activate two or more exhaust fans to ventilate the battery room simultaneously if the battery charger is presently charging a battery bank or if the hydrogen gas concentration is at or above the first threshold concentration. The fan control system can also active simultaneous exhaust fan operation when the battery charger is operating in a boost mode.

In certain embodiments, the monitoring device is configured to identify which of the plurality of battery banks is releasing hydrogen gas based on the output of the hydrogen detector when the hydrogen concentration is determined to be at or above the first threshold.

In certain embodiments, the system further includes at least one of a sound alarm and a visual alarm positioned near an entrance to the battery room. The monitoring device is configured to activate the sound alarm or visual alarm upon receipt of a signal from the hydrogen detector indicating that the hydrogen concentration is at or above the first threshold.

The system can also include a battery charger breaker coupled to the monitoring tool and the plurality of battery banks wherein the hydrogen detector is operative to output a signal indicating whether the hydrogen gas concentration is at or above a second threshold concentration higher than the first threshold and the monitoring device is configured to activate the battery charger breaker to halt charging of plurality of battery banks.

In some implementations, the first threshold concentration is set at 1 percent concentration by volume concentration and the second threshold is set at 2 percent concentration by volume.

The plurality of hydrogen sensors can include a sensor positioned on a ceiling of the battery room. The hydrogen detector can be configured to indicate that the hydrogen concentration is at or above the first threshold if 1) at least two of the hydrogen sensors positioned adjacent to the battery banks or 2) at least one of the hydrogen sensors positioned adjacent to the battery banks and the ceiling sensor, detect a hydrogen concentration at or above the first threshold

In some implementations, the monitoring device is configured to activate one of the plurality of exhaust fans at a time when output hydrogen detector indicates that the hydrogen concentration is below the first threshold.

The monitoring device can be configured to generate notifications to personnel including the identified location of the hydrogen release.

These and other aspects, features, and advantages can be appreciated from the following description of certain embodiments of the invention and the accompanying drawing figures and claims.

### BRIEF DESCRIPTION OF THE DRAWINGS

FIG. 1 is a schematic block diagram of an exemplary embodiment of a system for smart ventilation according to the present disclosure.

FIG. 2 is a schematic diagram of an embodiment of a circuit for switching from alternate to simultaneous fan operation according to the present disclosure.

FIG. 2A is a legend identifying elements in the schematic diagram of FIG. 2.

FIG. 3 is a schematic diagram of an exemplary battery and sensor deployment in a system for smart ventilation according to the present disclosure.

FIG. 4 is a flow chart of a method for smart ventilation according to an embodiment of the present disclosure.

### DETAILED DESCRIPTION OF CERTAIN EMBODIMENTS OF THE DISCLOSURE

Disclosed herein is a system and method for hydrogen gas detection and battery room ventilation. The disclosed system can provide proactive monitoring and prevention of hazardous gas levels in the battery room. Under normal conditions, a single exhaust fan is in operation. As a proactive measure to prevent hydrogen accumulation, simultaneous fans operation is activated as soon as the battery chagrin is triggered. Additionally, when a hydrogen volume concentration of equal to or greater than a first threshold (e.g., 1%) is detected, the system automatically triggers dual fan activation and notifies a centralized network operation center for immediate attention. Once the hydrogen volume concentration falls below the first threshold, the system switches the exhaust fans back to an alternating-fan mode, for instance, with just one fan in operation.

The disclosed system and method provide continuous ventilation with accelerated operation during the charging process or when the detected hydrogen volume concentration reaches or exceeds the first threshold. Automatic switching to accelerated operation is crucial for remote and hard-to-reach locations where field personnel cannot attend immediately to the problem in order to provide additional natural ventilation or fix the root cause of the excessive hydrogen release. Additionally, the disclosed system is equipped with visual and sound alerts at the battery room entrances that are adapted to alert personnel regarding the condition of the facility prior to anyone entering an affected room. Automatic calls are also sent to technical personnel for immediate attention and action. If the hydrogen concentration in the total air volume increases further and rises to a second, higher threshold (e.g., 2% or above), the system automatically sends communications over a computer or telephone network to escalate a report of this development to management.

Importantly, the disclosed system and method also determines the particular location within the facility from which the hazardous hydrogen concentration is emitting. This is accomplished by combining sensor readings. Moreover, in some embodiments, the disclosed system is coupled to a battery charge breaker so that the system it can trip the breaker if the hydrogen concentration reaches the second threshold. Normal operation can resume immediately after hazardous condition(s) have been cleared.

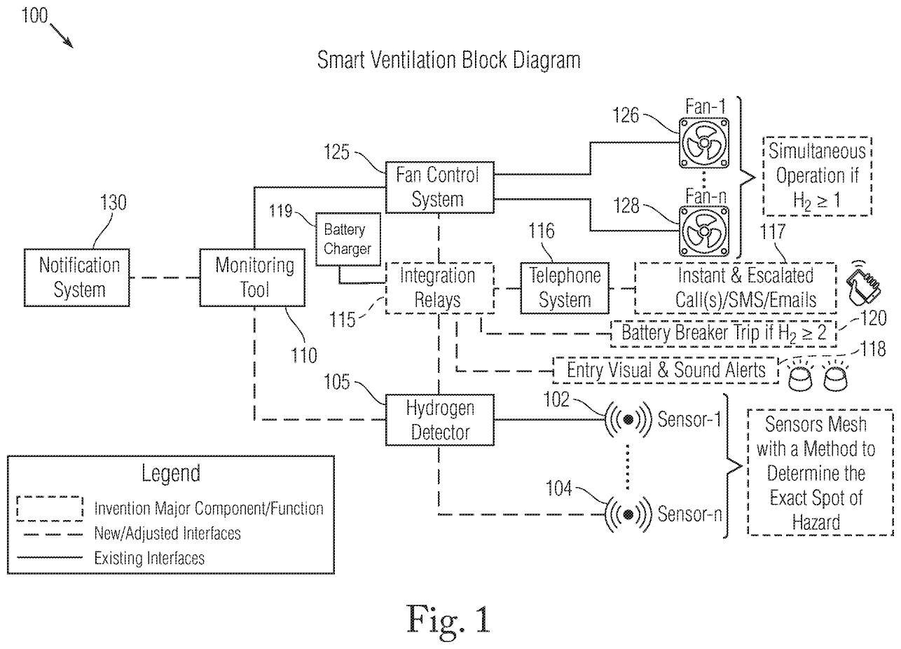

FIG. 1 is a schematic block diagram of an exemplary embodiment of a system 100 for smart ventilation according to the present disclosure. The system 100 is intended to be implemented within a battery room of a facility, such as an information technology (IT) facility in an organization. However, the system can be implemented at any location which is subject to hydrogen gas hazard risks. The battery room can enclose one or more flooded (wet) rechargeable lead-acid batteries or stacks thereof. While flooded lead-acid batteries have the advantage of rechargeability, during charging operations such batteries form and release hydrogen gas as result of hydrolysis reactions. The system 100 includes a plurality of sensors e.g., 102, 104 arranged in fixed positions in the battery room (for example, in a grid or mesh). While two sensors are explicitly depicted and labeled, it should be understood that any number (n) of sensors can be employed. The sensors 102, 104 can be chemical sensors that generate electrical signals having an amplitude proportional to the hydrogen concentration to which the sensors are exposed. The output of the sensors 102, 104 is delivered to a hydrogen detector 105. The hydrogen detector 105 includes electronic components that are configured to determine whether the output received from the sensors 102, 104 indicate that a threshold hazardous hydrogen concentration has been reached at one or more parts of the battery room. As described below, when more than one sensor is deployed, the hydrogen detector can determine the location of whichever sensor(s) indicate that the threshold concentration has been reached. In certain embodiments, the first hydrogen gas concentration threshold is set at 1% of the total gas volume in the battery room. The first threshold can be set higher or lower, depending on the particular safety target of the facility; as such, the first threshold can be a hydrogen concentration set point with a higher granularity than “1%,” for instance either 0.8% of the total gas volume in the battery room or 1.2% of the total gas volume in the battery room.

Hydrogen detector 105 generates an output signal indicative of whether the threshold has been reached. For example, a signal of amplitude x indicates that the hydrogen concentration at or exceeding the threshold has been detected. If the hydrogen concentration reaches a second, higher threshold, for instance and merely as an example, 2% of total gas volume, the hydrogen detector can generate an output signal of amplitude y indicating that hydrogen concentration at the second threshold has been detected. In some implementations, the hydrogen detector 105 generates continuously varying outputs. While differential amplitude is one manner in which the hydrogen detector can communicate detection information and the severity of any hydrogen gas concentration in the air, other modalities such as such as pulse width, multiplexed outputs and so on can be used to convey the same detection information, depending on the circuitry employed.

The hydrogen detector 105 is communicatively coupled to a monitoring device 110 and to one or more integration relays 115 which receive the output of the hydrogen detector. In certain embodiments, the monitoring device 110 and integration relays comprise functional modules executed using program code on a single host computing device. In other embodiments, the monitoring device 110 and integration relay(s) 115 are functional modules executed using program code or application specific circuits on separate devices. The integration relay(s) 115 is(are) coupled to a communication system 116 and to one or more room alert devices 118, such as sound alarms, flashing lights and any suitable devices that can warn personnel that the room is potentially unsafe and should not be entered or should be entered with caution or while wearing protective gear. Additionally, the integration relay(s) 115 is(are) coupled to the battery stack(s) 120 and to a fan control system 125.

The monitoring tool 110 more generally comprises a device which receives the output of the hydrogen detector 105 via the at least one integration relay 115. If the signal received from the hydrogen detector indicates that the first threshold hydrogen concentration has been detected, the monitoring device 110 executes safety related processes via the integration relay 115. For instance, the monitoring device 110, under control of software or circuitry, may deliver one or more communications 117 such as calls, emails or SMS messages through the communication system 116 to technical personnel that can respond to the hazardous condition. In some implementations, the delivered communications can be preconfigured in memory and accessed by the monitoring device 110 upon receipt of the signal indicating a hazardous hydrogen concentration from the hydrogen detector 105. The monitoring device 110 is also configured to generate an output signal to activate the alert devices 118 via the integration relay. The alert device 118 can be positioned on or near the door of the battery room and produce sound or lights to warn personnel in the facility. Integration relay 115 is also coupled to a battery charger 119 and can detect when the charger is in operation. The monitoring device 110 is configured to send commands to the fan control system 125 via integration relay 115.

As described in greater detail below, fan control system 125 operates at least two exhaust fans 126, 128. While two exhaust fans are explicitly labeled and depicted, the battery room can include more than two fans operated by the fan control system 125.

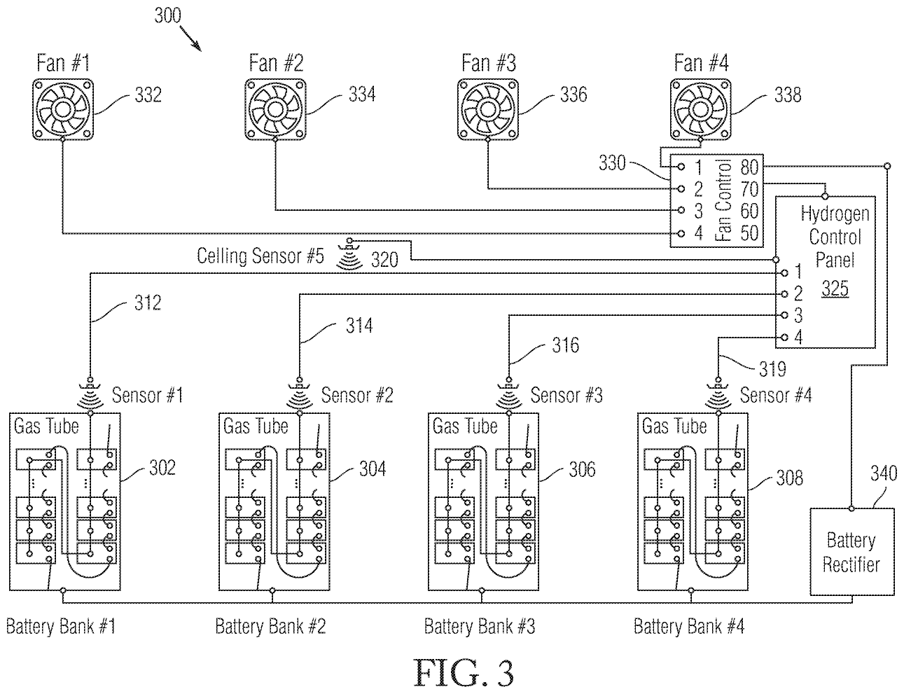

In an arrangement in which there are plural fans, there are at least two fan groupings, such that a first fan group and a second fan group can be operated in alternating sequence during “normal operation” and can be operated simultaneously during other operation modes in which hydrogen gas is to be evacuated more rapidly. Turning briefly to FIG. 3, fans 332 and 336 can be in a first fan group and fans 334 and 338 can be in a second fan group such that two fans are operated during the “normal operation” mode and four fans or all fans can be activated and operated when hydrogen gas is to be evacuated.

In response to a command signal received from monitoring device 110, which is sent when a hydrogen concentration equal to or greater than the first threshold has been detected, the fan control system 125 switches the exhaust fans 126, 128 from alternate operation to simultaneous operation. More specifically, during normal, alternate operation, when non-hazardous conditions prevail, the fan control system 125 operates one of the exhaust fans 126, 128 and then switches to the other fan after a certain duration has elapsed, for example, 3 hours. In this manner, one of the exhaust fans is always operating during normal conditions. When the first threshold hydrogen concentration is detected, the fan control system overrides alternate operation and operates both fans 126, 128 at the same time which—for similarly sized and configured fans—doubles the rate at which hydrogen gas can be exhausted out of the battery room.

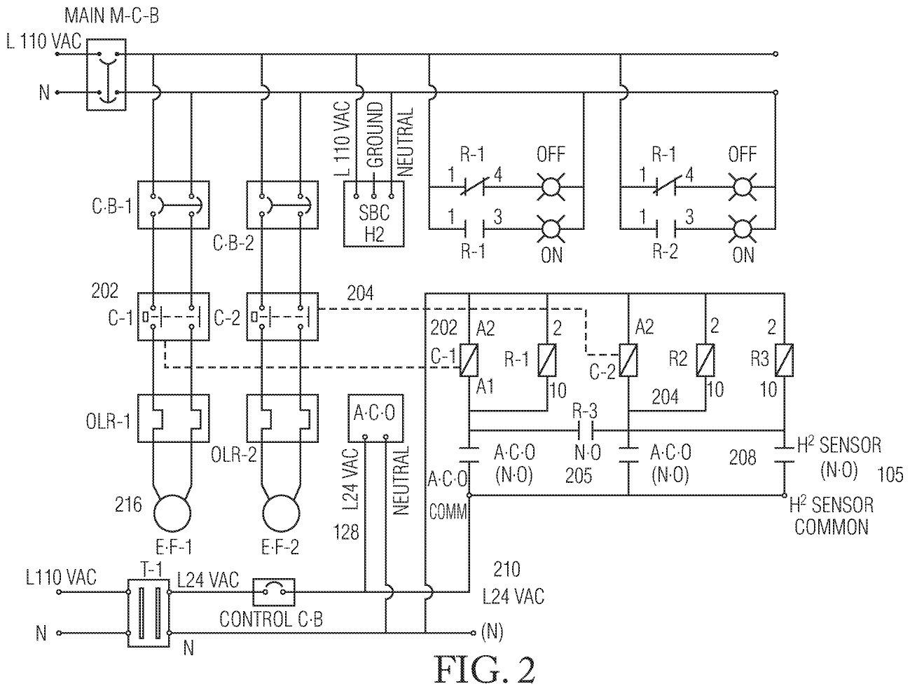

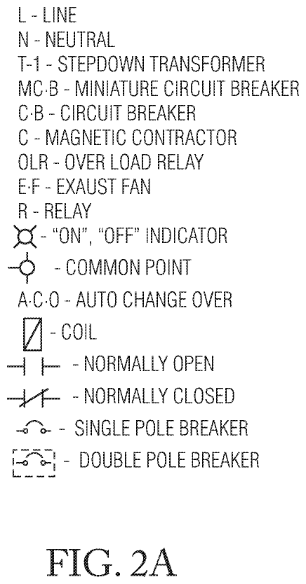

An exemplary circuit that can be used to implement the switchover operation of the fan control system is shown in FIG. 2, and an explanation of parts is illustrated in the legend of FIG. 2A. In FIG. 2, exhaust fans 126, 128 are controlled directly via respective contactors 202, 204 (both shown in two places in FIG. 2). A relay 205 with normally open (N.O.) contacts is coupled to a second relay with normally open contacts 208, which in turn, is coupled to and controlled by the hydrogen detector 105. Relay 205 is also coupled to contactors 202, 204. While relay 205 is in a normally open state, contactor 204 is not connected to power line 210 and is de-energized. If the hydrogen detector detects a hydrogen concentration above the first threshold, it changes the normally open point of relay 208 to normally closed (N.C.) which causes relay 205 to energize. When relay 205 energizes, it switches from normally open to normally closed (N.C.) which effectively connects both contactors 202, 204 to the power line, and triggers simultaneous exhaust fan operation. If the hydrogen level declines to less than 1% and the sensor alarm clears, then the relay 208 returns to a normally open position and the fans return to alternating mode operation.

The disclosed system also determines the precise location in the battery room at which a hazardous hydrogen has been detected. FIG. 3 is a schematic diagram of an exemplary battery and sensor deployment arrangement in a system for smart ventilation according to the present disclosure. In the arrangement shown in FIG. 3, a battery room 300 contains four battery banks 302, 304, 306 and 308. Hydrogen concentration sensors 312, 314, 316, 318 are positioned at gas tube outlets (“gas tube sensors”) of the respective battery banks 302-308, which, in this example, have a one-to-one relationship to respective battery banks. An additional hydrogen concentration sensor 320 is positioned on the ceiling of the room. All of the sensors 312, 314, 316, 318, 320 are communicatively coupled to and mapped onto a hydrogen sensor control panel 325 (which together with all of the sensors comprise the hydrogen detector in this embodiment). The sensor control panel 325 is also coupled to a fan control unit 330 which, in turn, is coupled to and controls operation of exhaust fans 332, 334, 336, and 338. The fan control unit 330 is further communicatively coupled to a battery rectifier 340 which is adapted to provide DC current to the battery packs 302-308. During operation, the exact location of a hydrogen release is determined by the activation pattern of the gas tube sensors as determined by the hydrogen control panel to which the sensors are mapped. In some embodiments, the fan control unit 330 is configured to activate simultaneous operation of at least two of the exhaust fans 332-338 when either 1) the battery charging is started 2) the ceiling sensor and one of the gas tube sensors or—3) two or more gas tube sensors indicate a hydrogen concentration at or above the first threshold.

Returning to FIG. 1, if the monitoring device 110 receives a signal from the hydrogen detector 105, via the integration relays 115, which indicates that the hydrogen concentration has reached the second threshold, the monitoring device is configured to generate an output signal to activate the battery circuit breaker 120. Activation of the battery circuit breaker stops all current battery charging operations, which halts any additional hydrogen production in the battery room. In addition, when the second threshold concentration is detected, the monitoring device 110 is configured to escalate notifications and to alert management of a potentially serious safety hazard via notification system 130. The monitoring device 110 is configured, by circuitry or code executing in association therewith, to generate and provide a prescribed communication which can include at least one call, text message, email, or combination of the foregoing, to ensure that management is made aware of the hazard immediately. In one embodiment, the notifications are further configured to include information provided by the monitoring device 110 which identifies the battery bank that is releasing hydrogen and which specifies that battery bank's location in the battery room, based on information received from the hydrogen detector.

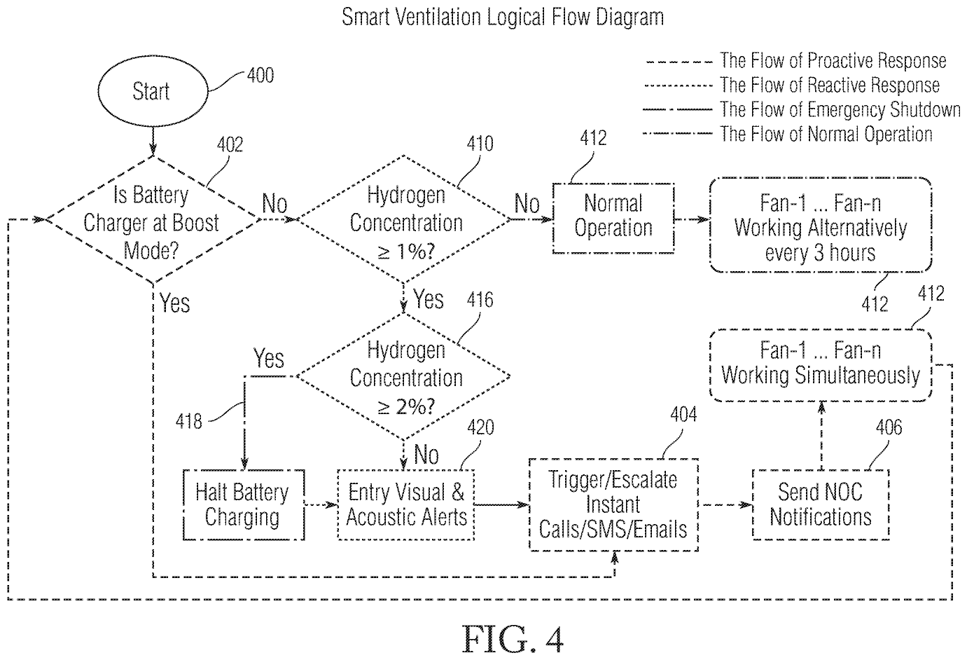

FIG. 4 is a flow chart of a method for smart ventilation according to an embodiment of the present disclosure. The method steps can be performed, based on executable program code or circuitry, by the monitoring device 110 in combination with the integration relay(s) 115. The method begins at step 400. In step 402, it is determined whether the battery charger is set to boost mode. In boost mode, battery chargers release hydrogen at an accelerated rate. Therefore, boost mode is treated like a hazardous hydrogen concentration as a precautionary measure. In certain implementations, the condition of the battery charger is detected by the monitoring device 110 which is coupled to the battery stacks and the battery rectifier 340 via the integration relays 115. If it is determined in step 402 that the battery charger is in charger mode, then in step 404, the monitoring device triggers an escalation by generating one or more prescribed notifications. In step 406, the prescribed notification(s) is(are) sent to a technical field team or other personnel to begin remediation procedures. Additionally, in step 408, the integration relay delivers a command to the fan control unit to operate the exhaust fans in a second fan-operation mode in which several fans are operated simultaneously, and more specifically, more fans than in a first, normal operation mode are operated simultaneously, as long as the charger is in boost mode. Following step 406, the process cycles back to step 402.

If, in step 402, it is determined that the battery charger is not in charger mode, in step 410, the monitoring device 110 determines whether the output of hydrogen detector indicates that the hydrogen concentration is at or above first threshold concentration (e.g., 1%). If it is determined that the hydrogen concentration is below the first threshold, in step 412 at least one integration relay sets an internal operation mode flag to “normal operation.” In step 414, based on the “normal operation” setting, the monitoring device generates a command to the fan control system to operate the exhaust fans in alternating mode in which a first fan-operation mode is engaged, such as one in which a single fan in the battery room operates for a certain duration (for example, 2-4 hours) and then switches off at the same time another fan is activated. If it is determined in in step 410 that the hydrogen concentration is at or above the first threshold, the process branches to step 416, in which the monitoring device determines whether the hydrogen concentration has reached the second threshold (e.g., 2%).

If it is determined, in step 416, that the hydrogen concentration is below the second threshold, in step 418, the monitoring device activates the alert devices to send visual and audio alerts to warn against entering the battery room. After step 418, the process returns to step 404, and the process continues as described above.

Returning to step 416, if it is determined that the hydrogen concentration is at or above the second threshold, in step 420, the monitoring device generates a command that halts the battery charging process and the fan-operation moves to the second fan-operation mode in which fans are operated simultaneously, and more fans are being operated than when in the first fan-operation mode which is only applicable to normal operation.

In the following step the process returns to step 418. After step 418 the process follows again with step 404, but this step is modified. Since the second threshold has been reached, there is an escalation in the notification process and prescribed notifications are generated and sent to management to indicate the presence of a possibly serious health hazard. After the hydrogen release is addressed, the monitoring device sends a command to the fan control system to resume normal (alternating) fan operation.

It is noted that the notifications sent to the technical field personnel preferably include information as to the specific battery bank at which hydrogen is being released. Notification regarding the location of the hydrogen release can save a great deal of time and effort since it removes the needed technical for personnel to spend time ascertaining the location of the release.

It is to be understood that any structural and functional details disclosed herein are not to be interpreted as limiting the systems and methods, but rather are provided as a representative embodiment and/or arrangement for teaching one skilled in the art one or more ways to implement the methods.

It is to be further understood that like numerals in the drawings represent like elements through the several figures, and that not all components and/or steps described and illustrated with reference to the figures are required for all embodiments or arrangements.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing, and are not to be construed as limiting. However, it is recognized these terms could be used with reference to a viewer. Accordingly, no limitations are implied or to be inferred.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A method of ventilating a battery room, comprising:
detecting a hydrogen concentration in the battery room;
determining whether the hydrogen gas concentration is at or above a first threshold concentration;
activating two or more exhaust fans to ventilate the battery room simultaneously when the hydrogen gas concentration is at or above the first threshold; and
identifying a location in the battery room at which hydrogen is being released.

2. The method of claim 1, further comprising:
determining whether any batteries in the battery room are currently being charged; and
wherein the step of activating the two or more exhaust fans to ventilate the battery room simultaneously activates the fans if the batteries are determined to be in a state of presently being charged or if the hydrogen gas concentration is at or above the first threshold concentration.

3. The method of claim 1, further comprising:
determining whether the whether the hydrogen gas concentration is at or above a second threshold concentration higher than the first threshold concentration; and
halting charging of batteries in the battery room when the hydrogen gas concentration is at or above the second threshold.

4. The method of claim 1, further comprising activating at least one of a sound and a visual alert when the hydrogen gas concentration is at or above the first threshold to warn personnel against entrance into the battery room.

5. The method of claim 1, wherein the battery room contains a plurality of battery banks and a plurality of hydrogen sensors, at least one of the plurality of hydrogen sensors being positioned at gas outlets of each of the plurality of battery banks, and wherein the location at which hydrogen is being released is determined based on which of the plurality of hydrogen sensors in the battery room detects an elevated hydrogen concentration.

6. The method of claim 5, wherein the plurality of hydrogen sensors further includes a ceiling sensor, and the step of determining whether the hydrogen gas concentration is at or above a first threshold concentration includes detecting a hydrogen concentration at or above the first threshold at a) two of the plurality of hydrogen sensors positioned at gas outlets of the battery banks, or b) at one of the plurality of hydrogen sensors positioned at gas outlets of the battery banks and at the ceiling sensor.

7. The method of claim 1, further comprising generating a notification and providing the notification to personnel when the hydrogen gas concentration is at or above the first threshold.

8. The method of claim 7, wherein the notification indicates the identified location in the battery room at which hydrogen is being released.

9. The method of claim 1, further comprising operating the two or more exhaust fans one at a time when the hydrogen gas concentration falls below the first threshold.

10. A system for ventilating a battery room comprising:
a plurality of exhaust fans positioned in the battery room;
a plurality of battery banks positioned in the battery room containing one or more batteries;
a plurality of hydrogen sensors, at least one of the plurality of hydrogen sensors positioned adjacent to each one of the plurality of battery banks;
a hydrogen detector coupled to the plurality of hydrogen sensors;
a monitoring device coupled to the hydrogen detector and to the plurality of exhaust fans;
wherein the hydrogen detector is operative to receive output from the plurality of hydrogen sensors and to generate a signal indicating a hydrogen concentration detected by the plurality of hydrogen sensors and the monitoring device is configured to operate a fan control system to activate two or more of the plurality of exhaust fans to operate simultaneously upon receipt of a signal from the hydrogen detector indicating that the hydrogen concentration is at or above the first threshold.

11. The system of claim 10, further comprising a battery charger coupled to the monitor, wherein the monitor is configured operate the fan control system to activate two or more exhaust fans to ventilate the battery room simultaneously if the battery charger is presently charging a battery bank or if the hydrogen gas concentration is at or above the first threshold concentration.

12. The system of claim 11, wherein the fan control system activates the two or more exhaust fan to ventilate the battery room simultaneous when the battery charger operates in a boost mode.

13. The system of claim 10, wherein the monitoring device is configured to identify which of the plurality of battery banks is releasing hydrogen gas based on the output of the hydrogen detector when the hydrogen concentration is determined to be at or above the first threshold.

14. The system of claim 10, further comprising at least one of a sound alarm and a visual alarm positioned near an entrance to the battery room, wherein the monitoring device is configured to activate the sound alarm or visual alarm upon receipt of a signal from the hydrogen detector indicating that the hydrogen concentration is at or above the first threshold.

15. The system of claim 10, further comprising a battery charger breaker coupled to the monitoring tool and the plurality of battery banks, wherein the hydrogen detector is operative to output a signal indicating whether the hydrogen gas concentration is at or above a second threshold concentration higher than the first threshold and the monitoring device is configured to activate the battery charger breaker to halt charging of plurality of battery banks.

16. The system of claim 15, wherein the first threshold concentration is 1 percent concentration by volume concentration and the second threshold is 2 percent concentration by volume.

17. The system of claim 15, wherein the plurality of hydrogen sensors further includes a sensor positioned on a ceiling of the battery room, and the hydrogen detector is configured to indicate that the hydrogen concentration is at or above the first threshold if 1) at least two of the hydrogen sensors positioned adjacent to the battery banks or 2) at least one of the hydrogen sensors positioned adjacent to the battery banks and the ceiling sensor detect a hydrogen concentration at or above the first threshold.

18. The system of claim 10, wherein the monitoring device is configured to activate one of the plurality of exhaust fans at a time when output hydrogen detector indicates that the hydrogen concentration is below the first threshold.

19. The system of claim 13, wherein the monitoring device is configured to generate and provide notifications to personnel including the identified location of the hydrogen release.
